(19) United States
(12) Patent Application Publication
(10) Pub. No.: US 2004/0195053 A1
(43) Pub. Date: Oct. 7, 2004

(54) Heat shield for a brake piston and brake actuator incorporating same

(76) Inventors: Stan Nowak, Balcatta (AU); Dorota H. Kieronska, Balcatta (AU); Vin C. Morley, Balcatta (AU)

Correspondence Address: ROTHWELL, FIGG, ERNST & MANBECK, P.C., 1425 K STREET, N.W., SUITE 800, WASHINGTON, DC, 20005, US

(21) Appl. No.: 10/488,004

(22) PCT Filed: Aug. 30, 2002
(86) PCT No.: PCT/AU02/01190

(51) Int. Cl. F16D 55/18

(52) U.S. Cl. 188/72.4

(57) ABSTRACT

A heat shield (10) for a brake piston (12) comprises a ring (14) made of a thermal insulating material. The ring (14) includes a radially inner circumferential wall (20), a radially outer circumferential wall (22), and at one axial end (24), a planar annular shield surface (26) that extends between the inner wall (20) and outer wall (22). A bead (28) extends radially inward from an inside surface of wall (20). The bead (28) sits within a groove (30) formed about the outer circumferential wall (16) of the piston (12) to effectively couple the ring (14) to the piston (12). When so coupled, the planar annular shield surface (26) is co-planar with an annular piston surface (52) formed at an open end (18) of the piston (12).

### FIELD OF THE INVENTION

The present invention relates to a heat shield for a brake piston and a brake actuator incorporating same, typically, though not exclusively, for use in brake calipers for pressing a brake pad onto a brake disc.

### BACKGROUND OF THE INVENTION

A typical brake actuator for a caliper disc brake includes one or more brake pistons housed within respective cylinders for pressing a brake pad onto a brake disc. The piston is often in the form of a short cylinder having a planar base at one end and open at an opposite end. The opposite end thus provides an annular surface and bears against a backing plate of a brake pad. The base on the other hand is disposed within the cylinder and is reacted upon by hydraulic fluid for extending the piston from the cylinder to apply a braking effect. The transfer of heat through the piston to the brake fluid can adversely effect the performance of the brake. In particular, when excessive heat is transferred the braking fluid is known to boil and evaporate and thus severely degrade brake performance.

A proposed solution to this problem is discussed in U.S. Pat. No. 6,146,727 (Dannels) which proposes a composite moulded plastic brake piston which comprises a phenolic resin body that is co-moulded to a skin which comprises a phenolic sheet moulding compound.

### SUMMARY OF THE INVENTION

It is an object of the present invention to provide a heat shield for use with a brake piston to attempt to reduce heat transfer and, to provide a brake actuator incorporating the heat shield.

According to the first aspect of the present invention there is provided a heat shield for a brake piston having a closed end disposed in a cylinder and an open end for abutment with a brake pad, said heat shield comprising a ring of a thermal insulating material adapted for coupling about an outer circumferential surface of said piston adjacent said open end.

Preferably said ring includes a radially inner circumferential wall, a radially outer circumferential wall, and, at a first axial end, a planar annular shield surface extending between said inner and outer circumferential walls, whereby, when said heat shield is attached to said piston, said planar annular shield surface is substantially co-planar with said open end.

Preferably said radially inner circumferential wall includes a circumferential bead for receipt within an annular groove formed about an outer circumferential surface of said piston.

Preferably said heat shield is made from polytetrafluoroethylene (PTFE).

Preferably said radially outer circumferential wall extends axially from said planar annular shield surface beyond said radially inner circumferential wall.

Preferably said heat shield includes an annular recess extending circumferentially between said radially inner circumferential wall and said radially outer circumferential wall.

According to a further aspect of the present invention there is provided an hydraulic brake actuator including at least:

a cylinder having a circumferential cylinder wall with a closed first axial end and an open second axial end forming an annular cylinder surface, a piston cavity being defined between said cylinder wall and said closed first axial end;

a piston having a circumferential piston wall, a bottom wall closing one axial end of said piston wall, with an opposite axial end of said piston wall being open and forming a planar annular piston surface, said piston seated in said piston cavity with said planar annular piston surface facing away from said closed first axial end of said cylinder; and a heat shield in the form of a ring made of a thermal insulating material coupled about an outer circumferential surface of said piston wall adjacent said annular piston surface.

Preferably said ring includes a radially inner circumferential wall a radially outer circumferential wall, and, at a first axial end, a planar annular shield surface extending between said radially inner and radially outer circumferential walls, wherein said planar annular shield surface is substantially co-planar with said planar annular piston surface.

Preferably said actuator further includes coupling means for releasably coupling said ring to said piston.

Preferably said coupling means includes seating means formed about an outer circumferential surface of said piston wall, and engaging means formed on said ring for receipt in said seating means.

Preferably said seating means includes an annular groove formed about said outer circumferential surface of said piston wall and said engaging means is a circumferential bead extending radially inwardly from said radially inner circumferential wall.

Preferably said radially outer circumferential wall of said ring depends axially from said planar annular shield surface beyond said radially inner circumferential wall.

Preferably said cylinder includes an annular face groove formed about said annular cylinder surface for receiving said radially outer circumferential wall of said ring.

Preferably said radially outer circumferential wall of said ring and said annular face groove are relatively dimensioned whereby, when said piston is extended to a maximum extent from said cylinder, said radially outer circumferential wall overlaps with said cylinder wall.

Preferably said actuator further includes a seal seated in an inner circumferential surface of said cylinder wall and bearing against said circumferential piston wall.

### BRIEF DESCRIPTION OF THE DRAWINGS

FIG. 1 is a sectional view of an embodiment of a heat shield in accordance with the present invention;

FIG. 2 is a sectional view of the heat shield of FIG. 1 applied to a brake piston;

FIG. 3 is a sectional view of an hydraulic brake actuator incorporating the heat shield and piston depicted in FIGS. 1 and 2 with no hydraulic pressure acting on said piston; and,

FIG. 4 is a sectional view of the actuator depicted in FIG. 3 with hydraulic pressure acting on the piston.

### DETAILED DESCRIPTION OF PREFERRED EMBODIMENT

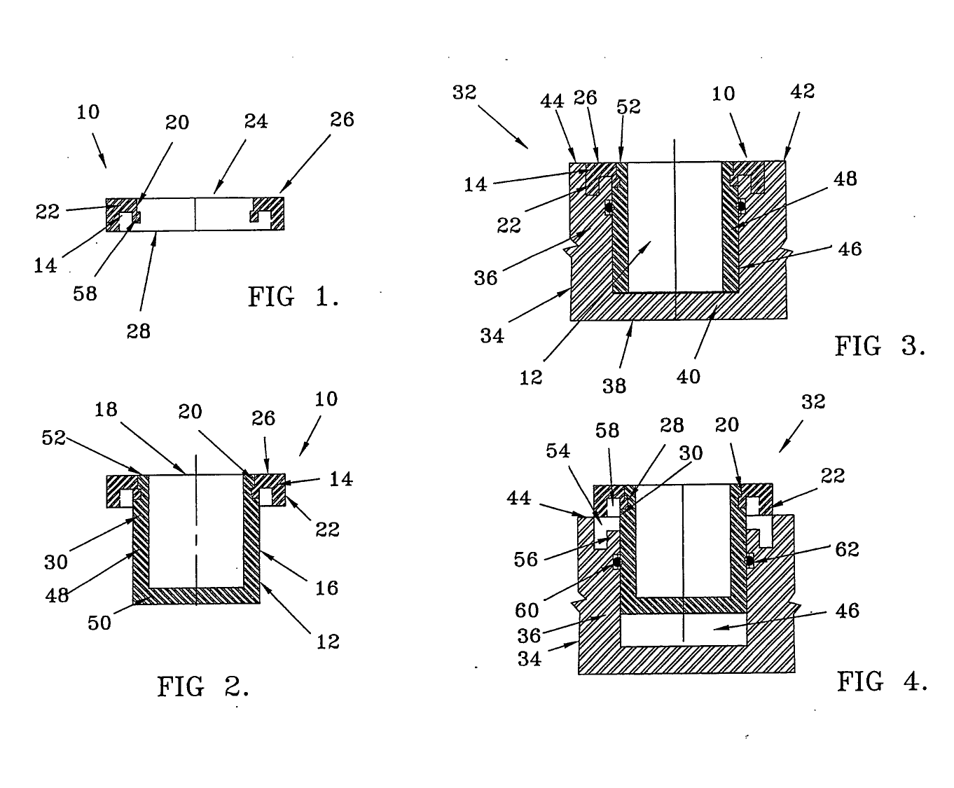

Referring to the accompanying drawings, and in particular FIGS. 1 and 2, a heat shield 10 for a brake piston 12 comprises a ring 14 of thermal insulating material which is adapted for coupling about an outer circumferential surface 16 of the piston 12 adjacent an open end 18 of the piston 12.

The ring 14 includes a radially inner circumferential wall 20, a radially outer circumferential wall 22, and at one axial end 24, a planar annular shield surface 26 that extends between the inner and outer walls 20, 22. The inner circumferential wall 20 is provided with engaging means in the form of a bead 28 that extends radially inwardly from the inside surface of wall 20. As shown most clearly in FIGS. 2-4, the bead 28 sits within a seating means in the form of annular groove 30 formed about the outer circumferential surface 16 of the piston 12.

As is further apparent from the Figures, the radially outer circumferential wall 22 depends axially from the planar annular surface 26 beyond the radially inner circumferential wall 20.

Ideally, the ring 10 is made from polytetrafluoroethylene (PTFE) with the beads 28 snap fitting into the groove 30 to provide a releasable coupling between the ring 14 and the piston 12.

FIGS. 3 and 4 provide a schematic representation of a brake actuator 32 which incorporates the heat shield 10. The actuator 32 includes the piston 12 and a cylinder 34.

The cylinder 34 has a circumferential wall 36 which is closed at a first axial end 38 by a wall 40, and is open at a second axial end 42 forming a planar annular cylinder surface 44. A piston cavity 46 is defined between the wall 36 and wall 40.

The piston 12 includes a cylindrical piston wall 48, a bottom wall 50 closing one axial end of the piston wall 48 and an annular piston surface 52 at an opposite end of the wall 48 extending about the open end 18. The outer circumferential surface 16 is the outer surface of the wall 48.

In the assembled actuator 32, the piston 12 is orientated within the cavity 46 so that the piston surface 52 faces away from the end 38 of the cylinder 34.

An annular face groove 54 is formed in the annular cylinder surface 44 for receiving the ring 14 and in particular the radially outer circumferential wail 22. The groove 54 is stepped to form an inner axially extending flange 56 that is able to seat within an annular recess 58 formed between the inner and outer circumferential walls 20 and 22 of the ring 14. This is most clearly depicted in FIG. 3.

An O-ring type seal 60 encapsulated in polytetrafluoroethylene (PTFE) is seated within a circumferential groove 62 formed on an inside circumferential wall of the cylinder 34.

The seal 60 maintains a fluid seal with the outer circumferential surface 16 of the piston 12.

The groove 54 and ring 14, and in particular the outer circumferential wall 22, are relatively dimentioned so that when the piston 12 is extended to its maximum extent from the cylinder 34, there remains an overlap between the outer circumferential wall 22 and the cylinder wall 36.

Embodiments of the present invention may be retrofitted to existing brake actuators. To this end, it is common for pistons 12 to be formed with annular grooves 30. However, in order to accommodate the heat shield 10, a conventional cylinder 34 will require machining in order to form the groove 54. Additionally, a further circumferential groove 62 will be required on the inside surface of cylinder wall 36 to accommodate the O-ring seal 60.

Initial tests indicate that use of the shield 10 leads to a reduction in temperature between 25° C. and 30° C. in comparison with an actuator 32 without the heat shield. In addition, the maintenance of an overlap between the radially outer circumferential wall 22 and the cylinder wall 36 assists in reducing the ingress of foreign matter into the hydraulic fluid operating within the cylinder 34.

Now that an embodiment of the present invention has been described in detail, it will be apparent to those skilled in the relevant arts that numerous modifications and variations may be made without departing from the basic inventive concepts. For example, the embodiment illustrates the provision of a mating groove 30 and bead 28 for releasably coupling the heat shield 10 to the piston 12. However other coupling means and mechanisms may be used. For example in place of the groove 30, two or more blind holes may be formed in the outer surface 16 of the piston 12 with a corresponding number of inwardly projecting tongues formed on the wall 32 for engaging in the holes. Further, the ring 10 may be made without the groove 58 with a complementary machining of the flange 56 in the cylinder 34.

All such modifications and variations together with others that would be obvious to a person of ordinary skill in the art are deemed to be within the scope of the present invention the nature of which is to be determined from the above description and the appended claims.

1. A heat shield for a brake piston having a closed end disposed in a cylinder and an open end for abutment with a brake pad, said heat shield comprising a ring of a thermal insulating material adapted for coupling about an outer circumferential surface of said piston adjacent said open end.

2. The heat shield according to claim 1 wherein said ring includes a radially inner circumferential wall, a radially outer circumferential wall, and, at a first axial end, a planar annular shield surface extending between said inner and outer circumferential walls, whereby, when said heat shield is attached to said piston, said planar annular shield surface is substantially co-planar with said open end.

3. The heat shield according to claim 2 wherein said radially inner circumferential wall includes a circumferential bead for receipt within an annular groove formed about an outer circumferential surface of said piston.

4. The heat shield according to claim 1 wherein said heat shield is made from polytetrafluoroethylene (PTFE).

5. The heat shield according to claim 2 wherein said radially outer circumferential wall extends axially from said planar annular shield surface beyond said radially inner circumferential wall.

6. The heat shield according to claim 2 wherein an annular recess extending circumferentially between said radially inner circumferential wall and said radially outer circumferential wall.

7. An hydraulic brake actuator including at least:
a cylinder having a circumferential cylinder wall with a closed first axial end and an open second axial end forming an annular cylinder surface, a piston cavity being defined between said cylinder wall and said closed first axial end;
a piston having a circumferential piston wall, a bottom wall closing one axial end of said piston wall, with an opposite axial end of said piston wall being open and forming a planar annular piston surface, said piston seated in said piston cavity with said planar annular piston surface facing away from said closed first axial end of said cylinder; and a heat shield in the form of a ring made of a thermal insulating material coupled about an outer circumferential surface of said piston wall adjacent said annular piston surface.

8. The brake according to claim 7 wherein said ring includes a radially inner circumferential wall, a radially outer circumferential wall, and, at a first axial end, a planar annular shield surface extending between said radially inner and radially outer circumferential walls, wherein said planar annular shield surface is substantially co-planar with said planar annular piston surface.

9. The brake actuator according to claim 7 wherein said actuator further includes coupling means for releasably coupling said ring to said piston.

10. The brake actuator according to claim 9 wherein said coupling means includes seating means formed about an outer circumferential surface of said piston wall, and engaging means formed on said ring for receipt in said seating means.

11. The brake actuator according to claim 10 wherein said seating means includes an annular groove formed about said outer circumferential surface of said piston wall and said engaging means is a circumferential bead extending radially inwardly from said radially inner circumferential wall.

12. The brake actuator according to claim 8 wherein said radially outer circumferential wall of said ring depends axially from said planar annular shield surface beyond said radially inner circumferential wall.

13. The brake actuator according to claim 8 wherein said cylinder includes an annular face groove formed about said annular cylinder surface for receiving said radially outer circumferential wall of said ring.

14. The brake actuator according to claim 13 wherein said radially outer circumferential wall of said ring and said annular face groove are relatively dimensioned whereby, when said piston is extended to a maximum extent from said cylinder, said radially outer circumferential wall overlaps with said cylinder wall.

15. The brake actuator according to claim 7 including a seal seated in an inner circumferential surface of said cylinder wall and bearing against said circumferential piston wall.
